(19) United States
(12) Patent Application Publication
(10) Pub. No.: US 2010/0088287 A1
(43) Pub. Date: Apr. 8, 2010

(54) INFORMATION SYSTEM, METHOD AND RECORDING MEDIUM HAVING PROGRAM RECORDED THEREON RELATING TO COLLECTIVELY REGISTERED DATA

(75) Inventor: Kazuhiro Taniguchi, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/569,656

(22) Filed: Sep. 29, 2009

(30) Foreign Application Priority Data
Oct. 3, 2008 (JP) 2008-258786

(51) Int. Cl. G06F 17/30

(52) U.S. Cl. 707/672; 707/E17.007

(57) ABSTRACT

An information system has a primary and a secondary system. The primary system includes a unit for processing data on a record; a unit for recording a processing result in a log; a unit for transferring the log recorded to the secondary system; a unit for collectively registering data of a plurality of records; a unit for notifying a collective registration log indicating execution of collectively registering the data; and a unit for transferring the collectively registered data. The secondary system includes a unit for acquiring a log; a unit for processing data on a record basis in a secondary database according to the acquired log; a unit for acquiring the data of the plurality of records to be collectively registered, if the acquired log is the collective registration log; and a unit for collectively reflecting, the data of the plurality of records to be collectively registered.

### CROSS-REFERENCE TO RELATED APPLICATIONS

This application is based upon and claims the benefit of priority of the prior Japanese Patent Application No. 2008-258786, filed on Oct. 3, 2008, the entire contents of which are incorporated herein by reference.

### FIELD

The technique to be disclosed relates to duplexing of an information system such as a database.

### BACKGROUND

One method of realizing database duplexing for the purposes of protection against disasters and load distribution is a database duplexing technique that uses update logs. In this technique, an update log resulting from updating a copy-source database (a primary system) by issuing an SQL (Structured Query Language) statement from an application program is transported to a copy-destination database (a secondary system) and reflected on data in the secondary system. FIG. 1 depicts the overview of this technique. In this technique, a database consists of a primary system and a secondary system. The primary system and the secondary system are interconnected via a log transport path. The log transport path consists of a disk device with a copy mechanism provided therewith, a file transfer function, network transfer, or the like.

The primary system has a database serving as a copy source, a database management system (hereinafter abbreviated as a DBMS) that executes SQL processing, and a duplexing system that transfers logs of the primary system to the secondary system. The secondary system has a database serving as a copy destination, a database management system (DBMS) that executes SQL processing, and a duplexing system that receives logs from the primary system.

In this system, for example, the DBMS receives a database update instruction in SQL and updates the database of the primary system. At this point, a log acquired in the primary system is passed to the secondary system via the duplexing system and the log transport path. The secondary system updates the database of the secondary system according to the passed log.

This technique has the following characteristics compared to a technique of duplexing a disk volume itself that stores data of the database.

(1) The amount of data transported between the primary system and the secondary system can be significantly reduced.

(2) The secondary system can be utilized while the duplexed database management is continued. That is, in this system, while the primary system is running as a currently used system, the secondary system is also active. Therefore, data in the secondary system is available to systems related to reference jobs and the like. Here, reference jobs refers to jobs of reading out and using data without updating the data.

(3) The physical structure, for example the disk volume arrangement, of the databases in both systems has flexibility. For example, the primary system and the secondary system can be constructed on disks that are remote from each other and that have different physical structures, respectively. The logical structure of both systems also has flexibility. For example, the systems can be constructed in areas having different path names, respectively.

However, in database management using this technique, the logs are recorded along with operations on a record basis, for example. On the other hand, database processing includes collectively registering a file from outside in the database (also called a load function). The collective registration refers to storing a plurality of records of an external file into the database in one registration process. Generally, when data of a file is collectively registered in the database, an update log that records the fact that the data has been updated is not generated, and the result of the collective registration of the file in the primary system is not reflected in the secondary system. Therefore, to collectively register a file in the duplexed database, a user needs to perform collective registration in the secondary system separately from the collective registration in the primary system, and this has been an impediment to convenience. To perform such collective registration in the duplexed system, the following management has been performed, for example.

(a) The duplexed system is stopped to perform collective registration in the secondary system in the same manner as in the primary system.

(b) A job cooperation function or the like implemented by the duplexed system is used to perform collective registration in the secondary system in the same manner as in the primary system.

However, in either way of management, the user needs to repeat the same operations in the primary system and the secondary system, and this makes the process troublesome.

To execute this function, it is necessary in either of the above-described choices to transport the same file as the one to be collectively registered in the primary system to the secondary system in advance, and to place scripts to be executed as user jobs (generally, scripts describing procedure statements for performing collective registration in a script language), as in Japanese Patent Laid-Open No. 2002-63058, for example (FIG. 2).

### BRIEF DESCRIPTION OF DRAWINGS

FIG. 1 depicts the overview of a database duplexing technique;

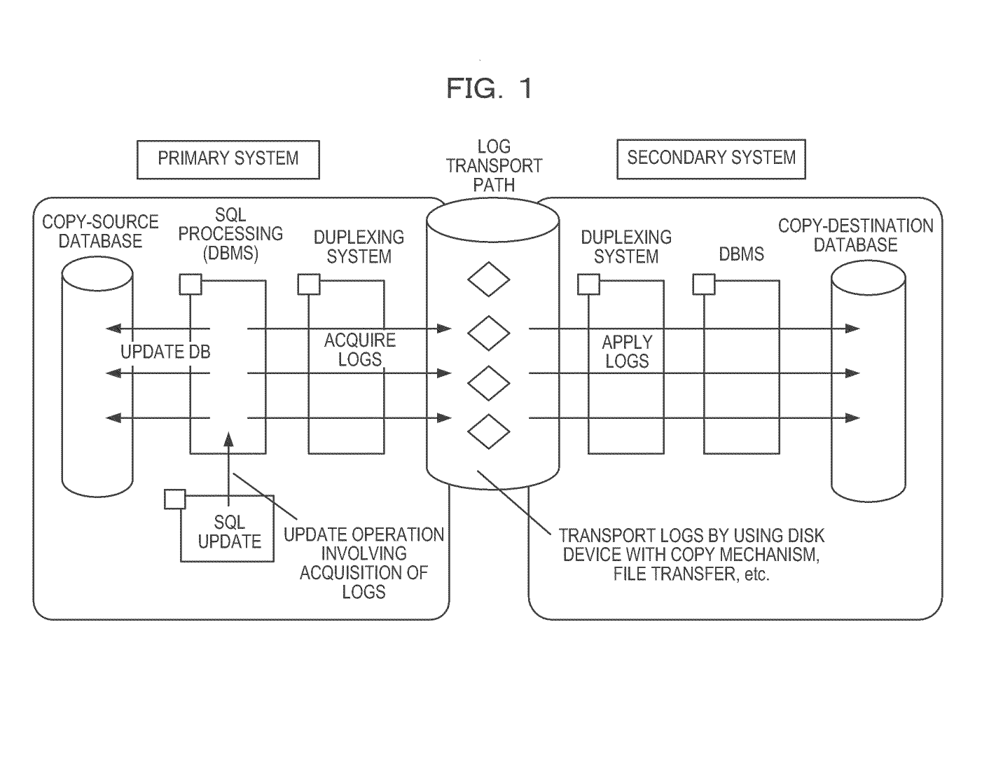

FIG. 2 is an example of performing database update operations without acquisition of logs in duplexed database management;

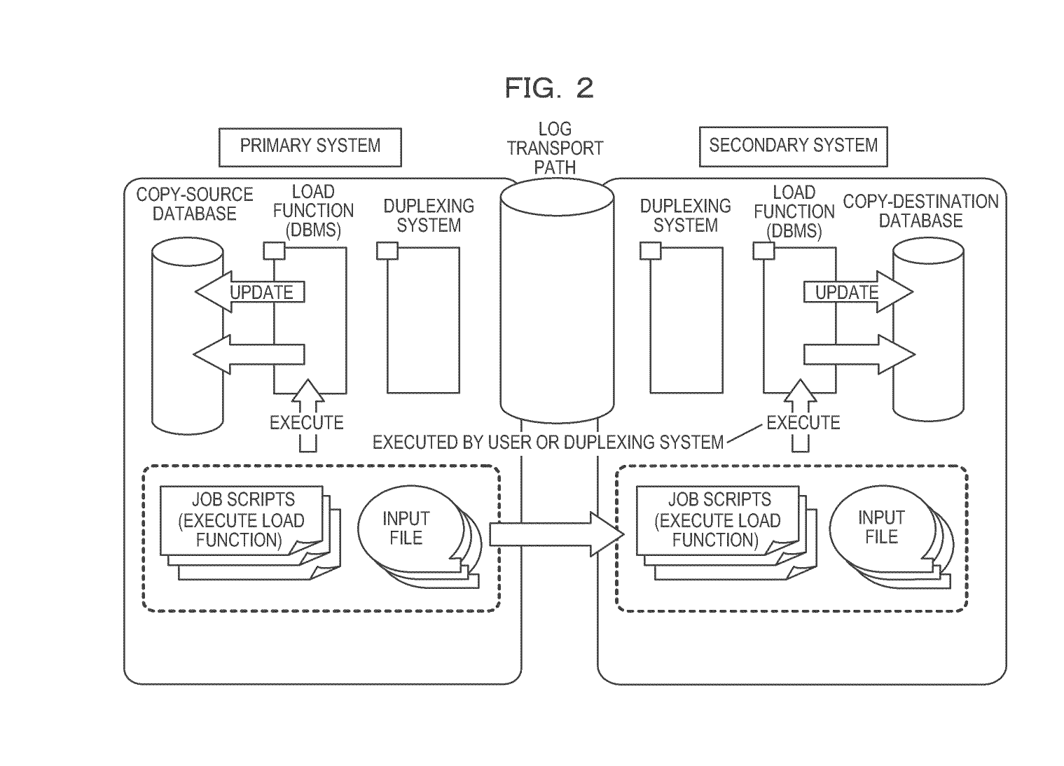

FIG. 3 is an example of exemplary processing in which duplexing in simple steps in the case of a load function is realized by using operation logs;

FIG. 4 depicts the operational overview of the load function in the embodiments;

FIG. 5 is an example of the structure of log transport paths;

FIG. 6 is an example of data structures of storage data transported to a secondary system;

FIG. 7 is an example of a processing configuration implemented by a primary system;

FIG. 8 is an example of a processing configuration implemented by the secondary system;

FIG. 9 depicts a processing flow in the primary system; and

FIG. 10 depicts a processing flow in the secondary system.

### SUMMARY

According to an aspect of the embodiment, an information system has a primary system and a secondary system interconnected via a log transport path.

The primary system includes:

a primary database;

a primary record processing unit for processing data on a record basis in the primary database;

a log recording unit for recording a processing result in a log when the data is processed by the primary record processing unit;

a transferring unit for the log recorded by the log recording unit to the secondary system via the log transport path;

a collective unit for registering data of a plurality of records from an external device;

a notifying unit, via the log transport path, for the secondary system of a collective registration log indicating execution of collectively registering the data of the plurality of records; and

a transferring unit for the collectively registered data of the plurality of records to the secondary system via a data transport path

The secondary system includes:

a secondary database;

an acquiring unit for acquiring a log from the primary system via the log transport path;

a secondary record processing unit for processing data on a record basis in the secondary database according to the acquired log;

an acquiring unit, via the data transport path, for the data of the plurality of records to be collectively registered, if the acquired log is the collective registration log; and

a collective reflecting unit, in the secondary database, for the data of the plurality of records to be collectively registered.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### DESCRIPTION OF EMBODIMENTS

An information system according to the best mode (hereinafter referred to as embodiments) for implementing the present invention will be described below with reference to the drawings. Configurations of the embodiments below are illustrative, and the present invention is not limited to the configurations of the embodiments.

### <System Overview>

This information system is a system that duplexes a database by transporting logs generated in a primary system to a secondary system. Generally, the database provides the following functions to application programs.

(1) A function of writing a record called a row, updating data in the record, and searching is provided. In this function, for example, a log is generated when a record is written. The generated log is stored as an update record for a database in the primary system and also transported to the secondary system via a log transport path. The log transported to the secondary system is used for updating a database in the secondary system.

(2) Besides writing to the database on a record basis, a collective registration function on the basis of a file including a plurality of records, i.e., a load function, is provided. In the load function, acquiring a log for each record while writing data to the database is not performed. In the load function, a plurality of records in an input file are collectively written to the database. Here, if an error occurs during the execution of the load function, data written up to that point cannot be recovered because logs on a record basis are not acquired. That is, if an execution error in the load function occurs, the load function needs to be redone from the beginning. In addition, since logs on a record basis are not acquired, writing in the primary system cannot be reflected in the secondary system by transporting logs.

(3) Collective registration by the load function is duplexed.

Therefore, this information system realizes database duplexing even in the case of the collective registration function in which data is collectively registered in the database without generation of logs in the primary system.

For this purpose, database update by the load function needs to be reproduced in the secondary system. As such, in order that data (rows, also called records) stored by using the load function may be reflected in the secondary system, means is necessary for transporting a data update log to the secondary system as the data is written to the database by executing the load function in the primary system.

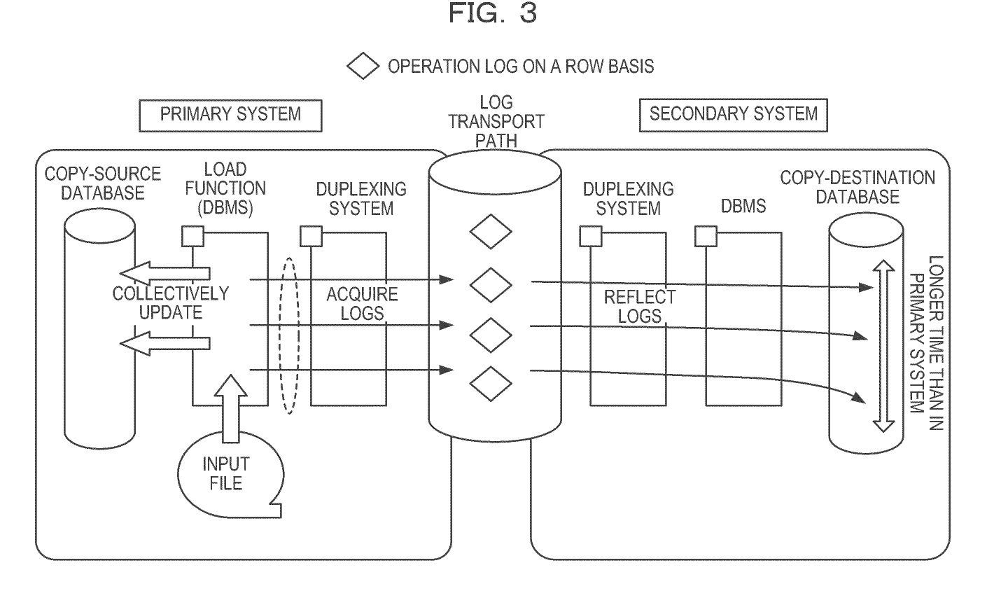

FIG. 3 illustrates processing in which duplexing in simple steps in the case of the load function is realized by transporting operation logs for the database. Here, among logs recorded for the database, a log indicating the start of a function of operating on data is called an operation log. Also, among logs recorded for the database, a log recorded when an individual record is updated will be called an update log. However, in the embodiments, both the operation log and the update log may be simply called logs without distinction between them. A CPU (or a DBMS) in the primary system that generates operation logs and update logs corresponds to log recording means.

In this example, a data update log is transported to the secondary system as data is written to the database by the load function in the primary system. In this step, when writing of a plurality of records occurs according to the load function in the database of the primary system, an update log is generated and transported to the secondary system via the log transport path every time writing of one record is completed, in the same manner as in normal data writing on a record basis. The secondary system can update the database according to the update logs acquired via the log transport path, in the same manner as in normal data writing on a record basis.

However, in the execution of the load function in the primary system, acquiring the update logs on a row (record) basis generated as the database is updated by an application program in this manner causes the following problems. This is because the load function originally realizes an increased speed by collectively updating input data (rows of a table) as one unit.

(A) The performance of the load function cannot be maintained. Overhead for acquiring an update log occurs for each processed row (record).

(B) Reflection of the update result of the load function in the secondary system is significantly delayed. Since database update by the duplexed system in the secondary system is performed according to the update logs, a database update cost (such as rereading a page that stores the row) required for each row (record) is necessary. Therefore, more time is necessary for reflecting the update logs in the secondary system than the processing time for the load function in the primary system, so that a situation arises in which the difference of data between the systems temporarily widens. As a result, in this technique, if the purpose of the duplexing is quick recovery from a failure, the amount of lost data at the occurrence of a failure increases: if the purpose of the duplexing is load distribution, the recentness of data to be referenced is compromised.

Therefore, by implementing the following processing, this information system realizes duplexing of data update by the load function while restraining the occurrence of the above problems (A) and (B).

That is, in this information system, as the update result of the load function in the primary system, rows to be stored are acquired as one unit (hereinafter referred to as storage data) rather than acquiring update logs on a row (record) basis. The rows to be transported are then collectively transported. Thus, the acquisition cost arising for each row is reduced. Also, the amount of transported data (such as information indicating a database resource) is reduced. The one unit is, for example, a page by which the database management system manages data. A page is also called a block.

On the other hand, database update in the secondary system is performed collectively for the transported unit of rows. A page structure in the database is generated from the unit of rows and directly written to a disk volume in which the database is placed. This reduces the cost (such as rereading a page) of database update on a row basis performed in the reflection mode using the conventional update logs. Therefore, the result of collective registration by executing the load function in the primary system can be quickly reflected in the secondary system. If the primary system acquires the page structure in the database and transports the page structure to the secondary system, the process of generating the page structure in the secondary system can further be omitted.

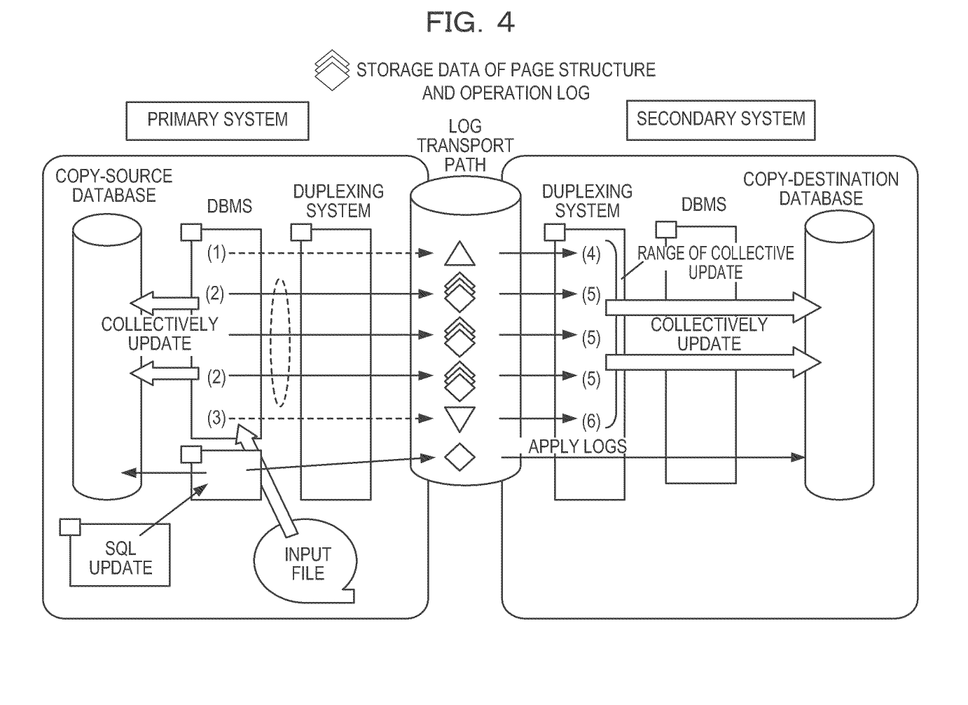

FIG. 4 depicts the operational overview of the load function in the embodiments. According to FIG. 4, execution steps of the load function in the primary system will first be described. The following items (1) to (3) correspond to processing (1) to (3) of the primary system in FIG. 4.

(1) When the execution of the load function is started, the primary system acquires an operation log indicating the start of the load function. The primary system transfers the operation log indicating the start of the load function (corresponding to a collective registration log) to the secondary system via the log transport path.

(2) The primary system then acquires storage data for the database (the copy-source database) in predetermined units from an input file and stores the storage data in the database. At this point, the primary system acquires, as a predetermined unit, the storage data for the database and an update log involved in the storage of the storage data. Here, the predetermined unit is a unit consisting of a plurality of rows to be stored in the database. Typically, the primary system acquires the storage data to be stored in the database on the basis of pages of the database. The primary system transfers the acquired page-based storage data and update logs to the secondary system via the log transport path.

(3) The primary system acquires an operation log indicating the finish of the load function.

Next, operations in the secondary system will be described. The following items (4) to (6) correspond to processing (4) to (6) of the secondary system in FIG. 4.

(4) The secondary system acquires the operation log of (1) via the log transport path. Upon recognizing the operation log indicating the start of the load function, the secondary system switches the database reflection mode to a storage mode in the predetermined units.

(5) The secondary system acquires the page-based storage data and the operation logs of (2) via the log transport path. The secondary system then collectively updates the database (the copy-destination database) based on the page-based storage data.

(6) Upon recognizing the operation log indicating the finish of the load function, the secondary system switches the reflection mode back to a log-based application mode.

Examples available for the transport path as an environment for implementing the processing in FIG. 4 are file transfer between computer systems, or a disk device with a copy function. In this case, the operation logs and the page-based storage data may be transferred via a single log transport path (corresponding to identical communication means). Alternatively, a plurality of log transport paths, for example a plurality of pairs of hard disk devices with a copy function, may be used to transfer the operation logs and the page-based storage data.

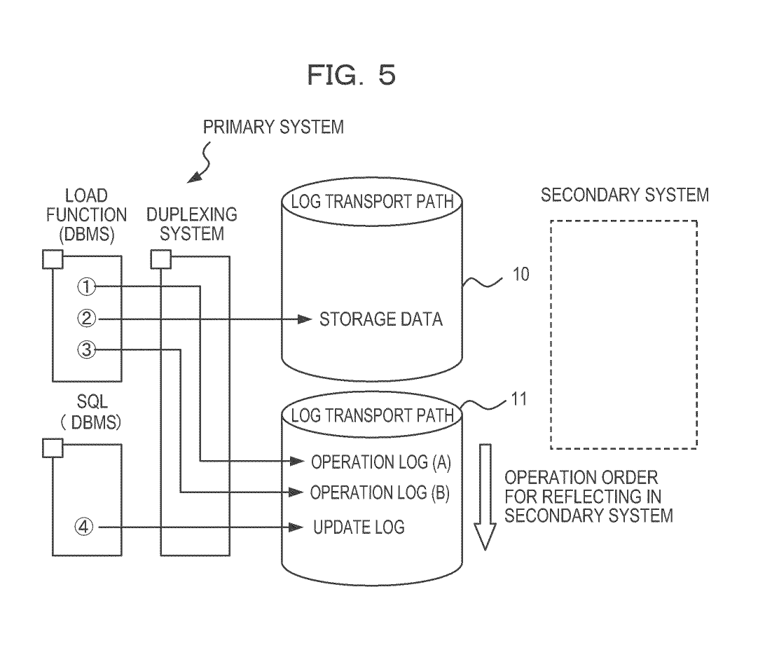

FIG. 5 depicts an exemplary system in which data is transferred via a plurality of log transport paths. In FIG. 5, the configuration of the secondary system is omitted. Since the storage data acquired by the load function is large in amount, the configuration as shown can be used to arrange the transport paths in a distributed manner. However, the operation logs need to share the same path for ensuring the execution order for reflection in the database.

The configuration of FIG. 5 is provided with a log transport path 10 (corresponding to a data transport path) for transferring the storage data for the database, and a log transport path 11 (corresponding to a log transport path) for transferring the operation logs according to the load function and the update logs according to the SQL. In this example, the following processing occurs in the primary system.

(1) an operation log A related to the storage data resulting from the load function

(2) storage of the storage data in the database

(3) an operation log B related to the storage data resulting from the load function

(4) an update log according to the SQL

In this case, the operation logs A and B, and the update log according to the SQL are transferred from the primary system to the secondary system via the log transport path 11. Therefore, in the secondary system, these logs are reflected in the database in order of the operation log A, the operation log B, and the update log, as received via the log transport path 11. Processing in this manner allows the result of storage in the database by the load function in the primary system to be faithfully reflected in the database of the secondary system.

Once the data in the log transport path is reflected in the secondary system, the area in the log transport path for this data becomes reusable. Therefore, a capacity for holding all storage data generated by the execution of the load function is not necessary.

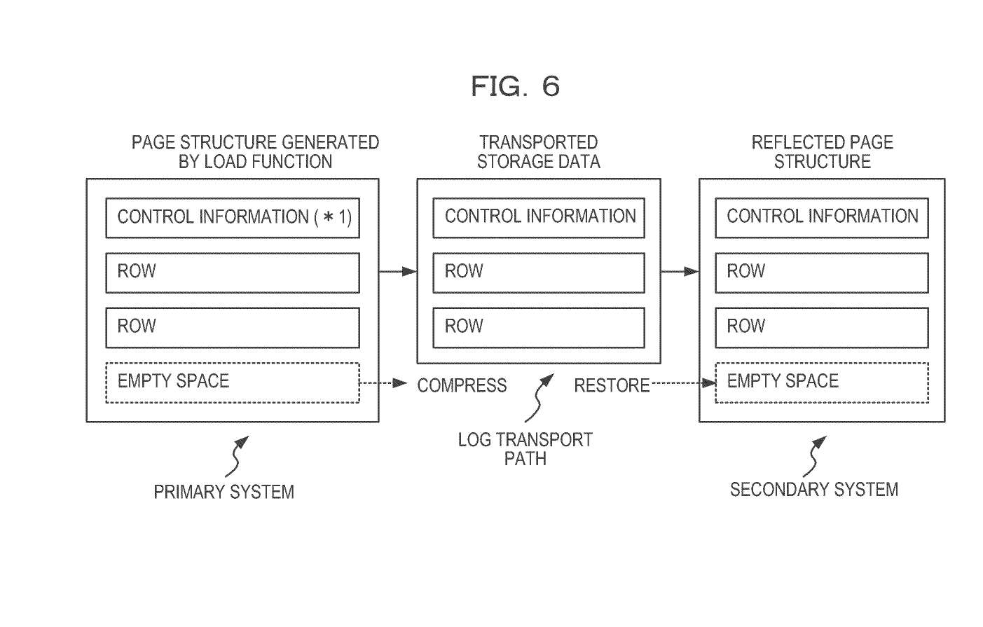

FIG. 6 illustrates data structures of the storage data transported to the secondary system. As in FIG. 6, the storage data transported to the secondary system includes control information and a plurality of rows. A unit of these rows is a page (or a block). The control information includes an identifier representing a resource (also called a table) in the database storage destination, a page number, an effective area length in the page, and the like. The area other than the effective area length is an empty space in the page.

In the example of FIG. 6, a page structure generated by the load function in the primary system has an empty space contained in the page. This empty space is not stored in the log transport path. That is, the primary system passes the storage data of the effective area length in the page to the log transport path. The secondary system then restores the empty space based on the effective area length in the control information.

As above, a characteristic of these data structures can be illustrated as not transporting the empty space as storage data if the page length does not align with the boundary of the rows. Thus, this information system enables reduction of the amount of data transported via the log transport path. Further, this information system enables reduction of the cost of generating the page structure in the secondary system.

### Examples

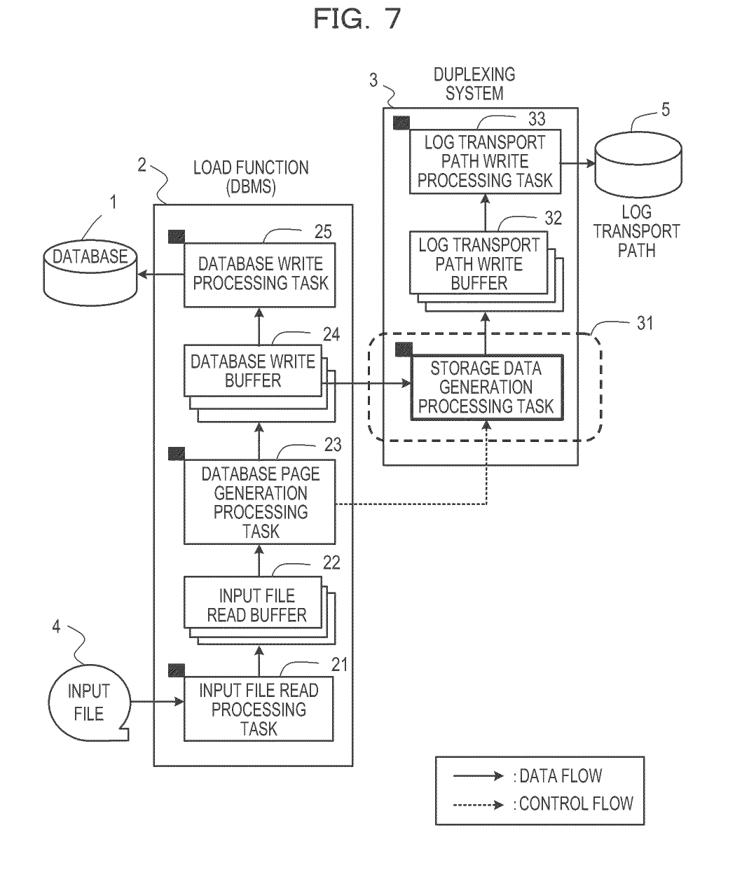

FIG. 7 illustrates a processing configuration implemented by the primary system. The primary system includes a database 1 (corresponding to a primary database), a database management system (DBMS) 2 having the load function, and a duplexing system 3, and is connected to the secondary system via a log transport path 5. The database 1 consists of a hard disk, for example. The DBMS 2 and the duplexing system 3 are implemented by a computer executing a computer program. The computer includes a CPU, memory, hard disks, a communication interface, a removable storage media drive, and the like, for example. The computer can communicate with external computers and servers via the communication interface. The computer can also read data via the removable storage media drive. Further, as the log transport path 5, one of the hard disks with a function of copying into a hard disk of the secondary system may be used, for example.

As in FIG. 7, an input file read processing task 21, a database page generation processing task 23, and a database write processing task 25 (corresponding to primary record processing means) are executed in the load function. The DBMS 2 executing the load function corresponds to means for collectively registering. The input file read processing task 21 reads an input file 4 to be stored in the database 1. The input file 4 (corresponding to an external device) is stored in a server on a network or stored on a removable storage medium. The input file read processing task 21 stores data of the read input file 4 in an input file read buffer 22.

The database page generation processing task 23 generates data of a page structure to be written to the database 1 from the data in the input file read buffer 22. The generated data of the page structure is stored in a database write buffer 24. At this point, the database page generation processing task 23 transfers the data of page structure in the database write buffer 24 to the duplexing system 3 (a storage data generation processing task 31). In other words, the database page generation processing task 23 instructs the storage data generation processing task 31 to read out the data of page structure in the write buffer 24. At this point, an operation log and an update log (a collective registration log) are generated and passed to the duplexing system. On the other hand, the database write processing task 25 stores, in the database 1, the data of page structure in the database write buffer 24.

The duplexing system 3 (corresponding to means for transferring to the secondary system via the log transport path, and means for notifying the secondary system) includes the storage data generation processing task 31 and a log transport path write processing task 33. The storage data generation processing task 31 receives the data of page structure, the operation log, and the update log, generated by the load function (the database page generation processing task 23) of the DBMS 2. Then, from the data of page structure, the storage data generation processing task 31 generates compressed data in which an empty space and the like have been compressed. The storage data generation processing task 31 stores the compressed data, the operation log, and the update log in a log transport path write buffer 32.

The log transport path write processing task 33 stores, in the log transport path 5, the compressed data in the log transport path write buffer 32. The log transport path 5 copies the compressed data, the operation log, and the update log into the hard disk of the secondary system.

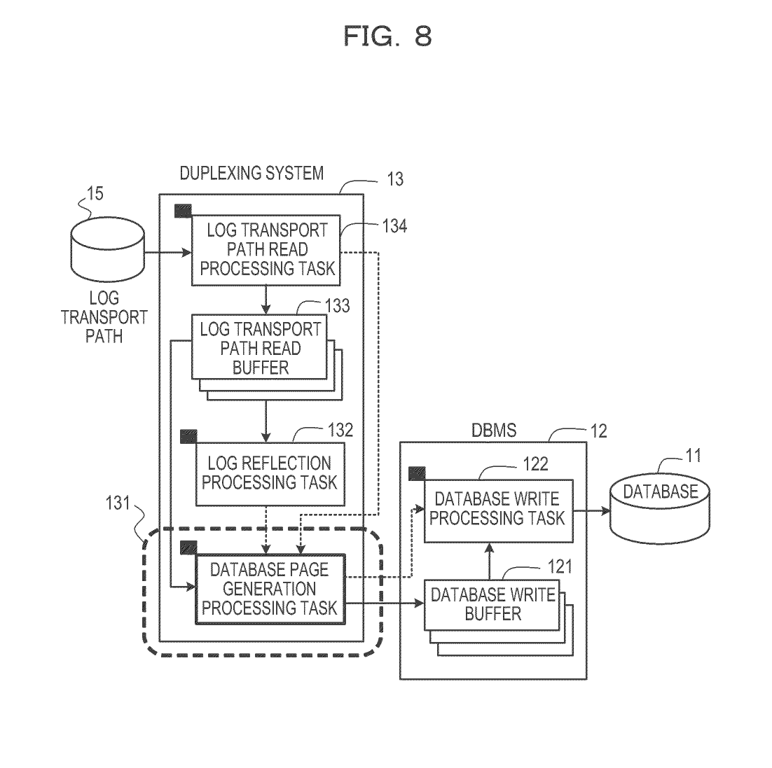

FIG. 8 illustrates a processing configuration implemented by the secondary system. The secondary system includes a database 11, a DBMS 12, and a duplexing system 13, and is connected to the primary system via a log transport path 15. The database 11 consists of a hard disk, for example. The DBMS 12 and the duplexing system 13 are implemented by a computer executing a computer program. The above configuration is the same as the primary system. Further, the log transport path 15 may include hard disks with a function of copying data from the hard disk of the primary system.

As in FIG. 8, the duplexing system 13 (corresponding to means for acquiring a log from the primary system and means for acquiring data of a plurality of records) executes a log transport path read processing task 134, a log reflection processing task 132, and a database page generation processing task 131. The log transport path read processing task 134 reads out the operation log, the update log, and the compressed data from the log transport path 15 and stores them in a log transport path read buffer 133.

The log reflection processing task 132 passes the operation log and the update log in the log transport path read buffer 133 to the database page generation processing task 131. The database page generation processing task 131 reads out the compressed data from the log transport path read buffer 133 according to the operation log and the update log. The database page generation processing task 131 then restores the data of page structure and stores it in a database write buffer 121.

The DBMS 12 executes a database write processing task 122. The database write processing task 122 collectively reflects, in the database 11, the data of page structure in the database write buffer 121. The database page generation processing task 131 and the database write processing task 122 correspond to means for collectively reflecting.

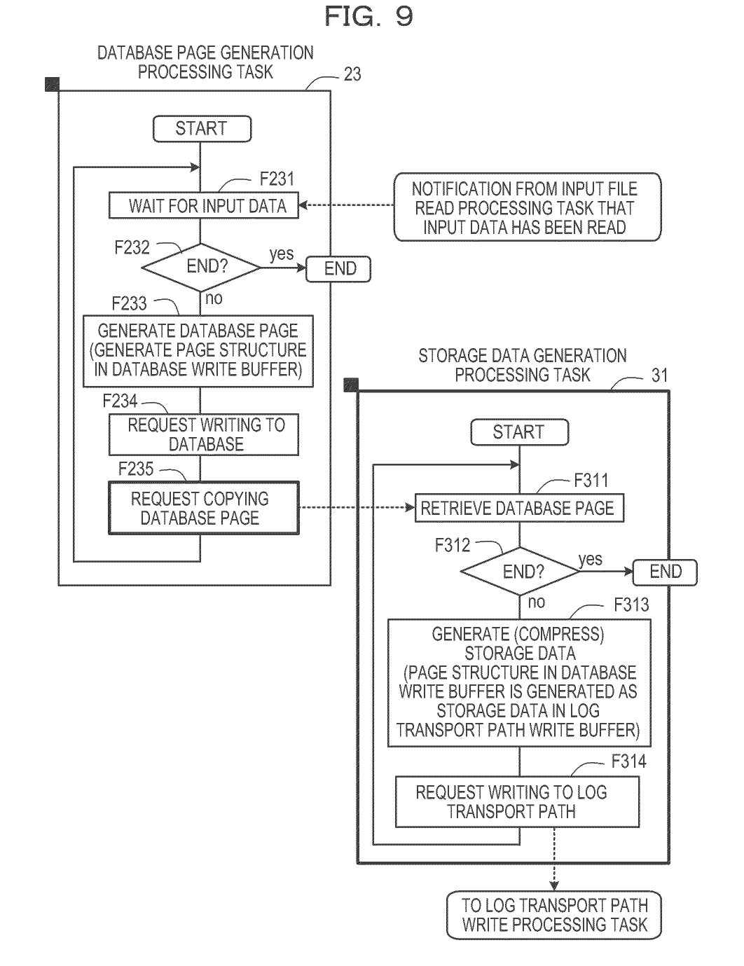

FIG. 9 illustrates a processing flow in the primary system. Here, processing of the database page generation processing task 23 and the storage data generation processing task 31 is illustrated. When the load function is started, the database page generation processing task 23 waits for input data (F231). The database page generation processing task 23 then performs end determination (F232). The end determination identifies end-of-file in the input file, for example. In this manner, the database page generation processing task 23 continues processing until all input data is processed.

The database page generation processing task 23 then generates data of a page structure of the database based on the data read from the input file. The data of the page structure of the database is generated in the database write buffer 24.

The database page generation processing task 23 then requests the database write processing task 25 to write the data in the database write buffer 24 to the database 1 (F234). Further, the database page generation processing task 23 requests the storage data generation processing task 31 to copy the data in the database write buffer 24 (F235). Thereafter, the database page generation processing task 23 returns the processing to F231.

The storage data generation processing task 31 retrieves the data in the database write buffer 24. The storage data generation processing task 31 then performs end determination (F312). The end determination is based on reception of end-of-file, for example. In this manner, processing continues until all data is processed.

The storage data generation processing task 31 then generates data to be written to the log transport path (F313). For example, the storage data generation processing task 31 generates compressed data in which an empty space in the data of page structure has been compressed. The generated compressed data is stored in the log transport path write buffer 32. The storage data generation processing task 31 then requests the log transport path write processing task 33 to write the compressed data in the log transport path write buffer 32 to the log transport path 5 (F314). Thereafter, the storage data generation processing task 31 returns the processing to F311.

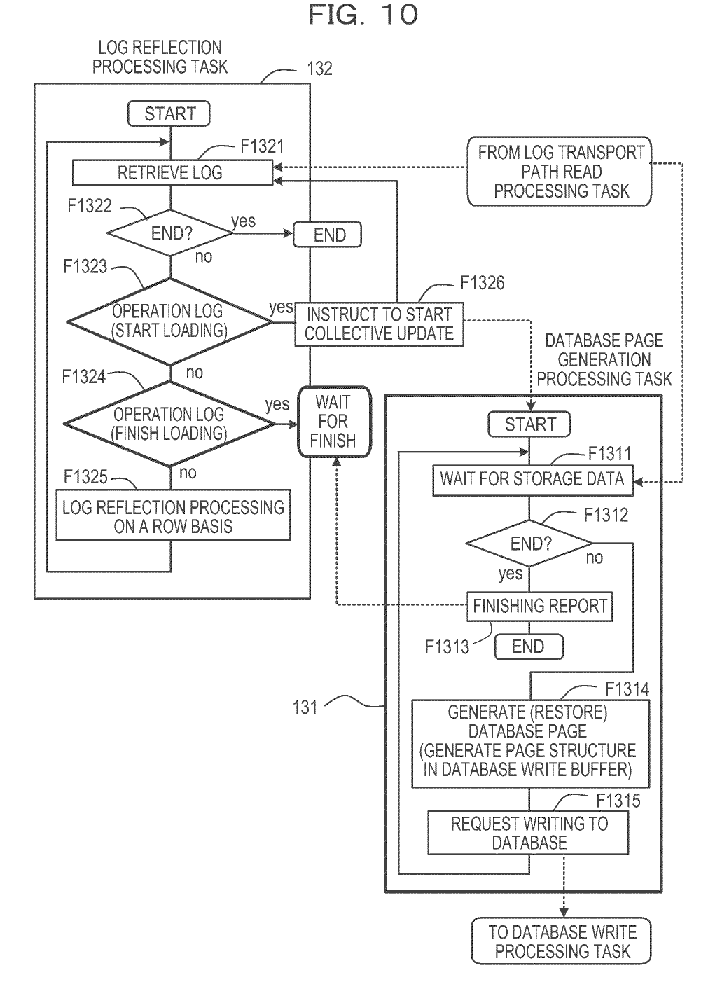

FIG. 10 illustrates a processing flow in the secondary system. Here, processing of the log reflection processing task 132 and the database page generation processing task 131 is illustrated. When receiving a read notification from the log transport path read processing task 134, the log reflection processing task 132 starts processing. The log reflection processing task 132 retrieves a log from the log transport path read buffer 133 (F1321). The log reflection processing task 132 then performs end determination. The end determination is based on reception of an operation log indicating the finish of the load function, for example. Alternatively, indication information indicating the finish of the load function may be received from the log transport path 15. In this manner, the log reflection processing task 132 continues processing until all data is reflected in the database 11.

If the log reflection processing task 132 receives an operation log to start loading (if YES in F1323), the log reflection processing task 132 instructs the database page generation processing task 131 to perform collective update (F1326). Thereafter, the log reflection processing task 132 returns the processing to F1321 and retrieves the next log.

After the operation log to start loading is received, if a log to finish loading is further received, the log reflection processing task 132 waits for a finishing report of the database page generation processing task 131. When receiving the finishing report of the database page generation processing task 131, the log reflection processing task 132 returns the processing to F1321 and processes the next log.

If a log other than the logs to start loading and finish loading is received, the log reflection processing task 132 reflects the log in the database 11 on a row basis as normal (F1325). Thereafter, the log reflection processing task 132 returns the processing to F1321 and processes the next log. In this manner, the operation order for the same resource (table) can be ensured. On the other hand, operations for different resources (tables) are performed independently from each other resource by parallel processes.

The database page generation processing task 131 also starts processing when receiving the read notification from the log transport path read processing task 134. The database page generation processing task 131 waits for storage of data in the log transport path read buffer 133 (F1311). The database page generation processing task 131 then performs end determination. The end determination is based on detection of end-of-file that is output from the log transport path read processing task 134, for example. When end-of-file is detected, the database page generation processing task 131 sends a finishing report to the log reflection processing task 132 (F1313). Thereafter, the log reflection processing task 132 is finished. In this manner, the database page generation processing task 131 continues processing until all data is processed.

If the end determination results in that the processing is not finished, the database page generation processing task 131 restores a page structure of the database (F1314). Specifically, the database page generation processing task 131 generates a page structure that contains an empty space from the compressed data. The database page generation processing task 131 then requests the database page write processing task to write to the database (F1315). The database page generation processing task 131 then returns the control to F1311 and processes the next storage data.

### <Advantages>

As has been described above, the disclosed technique is applied to a system employing a database duplexing method in which logs resulting from updating a copy-source database is transported to and applied to a copy-destination database. While taking advantage of the characteristics of this method, the disclosed technique enables duplexing of database management that uses the load function, without being aware that the system is a duplexed system. That is, for a function like the database load function in which duplexing is not performed by using operation logs, data update by the load function in the primary system is reflected in the secondary system without executing the load function individually in the primary system and the secondary system. In this case, updated data is restored in the secondary system by transferring a log indicating the start of the load function, a log indicating the finish of the load function, and data of a page structure, without generating an operation log for each row. As a result, the updated data can be reflected in the secondary system while restraining the reduction of the efficiency of the load function. Thus, setup and management in the secondary system conventionally necessary for each application of the load function is now unnecessary, so that the convenience of database management is increased.

There are cases where the consistency of database data is left to the user in such a manner that the user stops the duplexed system before executing the load function. However, in the disclosed technique, an advantage of increased reliability can also be expected because the execution order and operations are realized by the duplexed system.

In the disclosed system, an empty space in the page structure is excluded, and the data is sent and received in a form of compressed data between the log transport paths 5 and 15. This enables efficient use of the log transport paths.

In the above description, when data collectively registered in the primary system by the load function is reflected in the secondary system, data on a page basis is acquired and transported from the primary system to the secondary system. Also, update logs resulting from storing the data in the primary database on a page basis is acquired in the primary system and transported to the secondary system. However, the disclosed technique is not limited to such processing on a page basis. For example, data collectively registered in the primary system may be reflected in the secondary system on the basis of a unit of a plurality of pages. The above processing may also be performed on the basis of a unit smaller than a page.

### <Computer-Readable Recording Medium>

A program that causes a computer or other machines and apparatuses (hereinafter referred to as a computer etc.) to implement any of the above-described functions can be recorded on a recording medium readable by the computer etc. The computer etc. can then be caused to read and execute the program on the recording medium to provide the functions.

Here, the recording medium readable by the computer etc. refers to a recording medium that can store information such as data and program by electric, magnetic, optical, mechanical, or chemical action so that the computer etc. can read the information. Among such recording media, recording media removable from the computer etc. include a flexible disk, magneto-optical disk, CD-ROM, CD-R/W, DVD, DAT, 8 mm tape, and memory card, for example.

Recording media fixed to the computer etc. include a hard disk and ROM (Read Only Memory).

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has(have) been described in detail, it should be understood that the various changes, substitutions, and alterations could be made hereto without departing from the spirit and scope of the invention.

1. An information system having a primary system and a secondary system interconnected via a log transport path, wherein
the primary system comprises:
a primary database;
primary record processing means for processing data on a record basis in the primary database;
log recording means for recording a processing result in a log when the data is processed by the primary record processing means;
means for transferring the log recorded by the log recording means to the secondary system via the log transport path;
means for collectively registering data of a plurality of records from an external device;
means for notifying, via the log transport path, the secondary system of a collective registration log indicating execution of processing of collectively registering the data of the plurality of records; and
means for transferring the collectively registered data of the plurality of records to the secondary system via a data transport path, and
the secondary system comprises:
a secondary database;
means for acquiring a log from the primary system via the log transport path;
secondary record processing means for processing data on a record basis in the secondary database according to the acquired log;
means for acquiring, via the data transport path, the data of the plurality of records to be collectively registered, if the acquired log is the collective registration log; and
means for collectively reflecting, in the secondary database, the data of the plurality of records to be collectively registered.

2. The information system according to claim 1, comprising
communication means in which the log transport path and the data transport path are identical.

3. An information processing method performed by an information system having a primary system and a secondary system interconnected via a log transport path, comprising
steps for the primary system of:
processing data on a record basis in a primary database;
recording a processing result in a log when the data is processed in the primary record processing step;
transferring the recorded log to the secondary system via the log transport path;
collectively registering data of a plurality of records from an external device;
notifying, via the log transport path, the secondary system of a collective registration log indicating execution of collective registration of the data of the plurality of records; and
transferring the collectively registered data of the plurality of records to the secondary system via a data transport path, and
steps for the secondary system of:
processing data on a record basis in a secondary database according to a log acquired from the primary system via the log transport path;
acquiring, via the data transport path, the data of the plurality of records to be collectively registered, if the acquired log is the collective registration log; and
collectively reflecting, in the secondary database, the data of the plurality of records to be collectively registered.

4. A recording medium having recorded thereon a program executed in an information system communicating with a secondary system that processes data on a record basis in a secondary database according to a log acquired via a log transport path, acquires, via a data transport path, data of a plurality of records to be collectively registered if the acquired log is a collective registration log, and collectively reflects, in the secondary database, the data of the plurality of records to be collectively registered, the program causing the information system to perform:
a primary record processing step of processing data on a record basis in a primary database;
a log recording step of recording a processing result in a log when the data is processed in the primary record processing step;
a step of transferring the log recorded in the log recording step to the secondary system via the log transport path;
a step of collectively registering data of a plurality of records from an external device;
a step of notifying, via the log transport path, the secondary system of the collective registration log indicating execution of the step of collectively registering the data of the plurality of records; and
a step of transferring the collectively registered data of the plurality of records to the secondary system via the data transport path.
